(19) United States
(12) Patent Application Publication
(10) Pub. No.: US 2006/0248060 A1
(43) Pub. Date: Nov. 2, 2006

(54) Search results web page with provisions for e-mailing individual search results

(76) Inventors: Marc E. Silverberg, Oakland, CA (US); Kevin J. Wray, San Carlos, CA (US)

Correspondence Address: OKAMOTO & BENEDICTO, LLP, P.O. BOX 641330, SAN JOSE, CA, 95164, US

(21) Appl. No.: 11/219,036

(22) Filed: Sep. 1, 2005

Related U.S. Application Data
(60) Provisional application No. 60/670,850, filed on Apr. 13, 2005.
(60) Provisional application No. 60/704,779, filed on Aug. 1, 2005.
(60) Provisional application No. 60/684,817, filed on May 26, 2005.

(51) Int. Cl. G06F 7/00

(52) U.S. Cl. 707/3

(57) ABSTRACT

In one embodiment, a first search results web page includes an e-mail icon for each search result. Activating the e-mail icon includes the search result in a compilation of search results. Selected search results in the compilation of search results may be e-mailed to one or more e-mail addresses. The first search results web page may be displayed at the same time on the same computer screen as a second search results web page, with the first and second search results web pages being from different unrelated search engines and containing search results that are responsive to the same keyword.

### CROSS-REFERENCE TO RELATED APPLICATION

This application claims the benefit of U.S. Provisional Application No. 60/670,850, filed on Apr. 13, 2005 and U.S. Provisional Application No. 60/704,779, filed on Aug. 1, 2005, which are both incorporated herein by reference in their entirety.

This application is related to U.S. Provisional Application No. 60/684,817, filed on May 26, 2005, which is incorporated herein by reference in its entirety.

### BACKGROUND OF THE INVENTION

1. Field of the Invention

The present invention relates generally to computer systems, and more particularly but not exclusively to search results

2. Description of the Background Art

The Internet is an example of a computer network. On the Internet, end-users on client computers may access various types of information resident in server computers. A server computer that provides information over the Internet is also referred to as a “web server” or a “website”. A website may provide information about various topics or offer goods and services. A website may comprise a plurality of downloadable documents, such as web pages and files. An end-user may use a web browser to receive and view a web page.

Because of the large number of websites on the Internet, searching the Internet for specific information usually requires the services of a search engine. Generally speaking, a search engine helps end-users look for relevant web pages. A typical search engine accepts a word or a phrase, referred to herein as a “keyword.” The search engine employs the keyword in conjunction with its search algorithm to find matching web pages. The matching web pages are presented to the end-user in the form of a listing referred to as “search results.” Typical search results list the matching web pages as clickable links, with each link pointing to a corresponding web page. Examples of websites with search engines include Yahoo, Google, and Alta Vista.

To improve the usefulness of search results and make the search engine more attractive to end-users, it is desirable to augment the features and information available in web pages containing the search results.

### SUMMARY

In one embodiment, a first search results web page includes an e-mail icon for each search result. Activating the e-mail icon includes the search result in a compilation of search results. Selected search results in the compilation of search results may be e-mailed to one or more e-mail addresses. The first search results web page may be displayed at the same time on the same computer screen as a second search results web page, with the first and second search results web pages being from different unrelated search engines and containing search results that are responsive to the same keyword.

These and other features of the present invention will be readily apparent to persons of ordinary skill in the art upon reading the entirety of this disclosure, which includes the accompanying drawings and claims.

### DESCRIPTION OF THE DRAWINGS

FIG. 1 shows a schematic diagram of an example computer that may be used in embodiments of the present invention.

FIG. 2 shows a schematic diagram of a computing environment in accordance with an embodiment of the present invention.

FIG. 3 shows an example web page displayed in a window of a web browser in a client computer.

FIG. 4, which consists of FIGS. 4A, 4B, and 4C, shows a search results web page in accordance with embodiment of the present invention.

FIGS. 5 and 6 show search results web pages in accordance with other embodiments of the present invention.

The use of the same reference label in different drawings indicates the same or like components.

### DETAILED DESCRIPTION

In the present disclosure, numerous specific details are provided, such as examples of apparatus, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Being computer-related, it can be appreciated that the components disclosed herein may be implemented in hardware, software, or a combination of hardware and software (e.g., firmware). Software components may be in the form of computer-readable program code stored in a computer-readable storage medium, such as memory, mass storage device, or removable storage device. For example, a computer-readable medium may comprise computer-readable program code for performing the function of a particular component. Likewise, computer memory may be configured to include one or more components, which may then be executed by a processor. Components may be implemented separately in multiple modules or together in a single module.

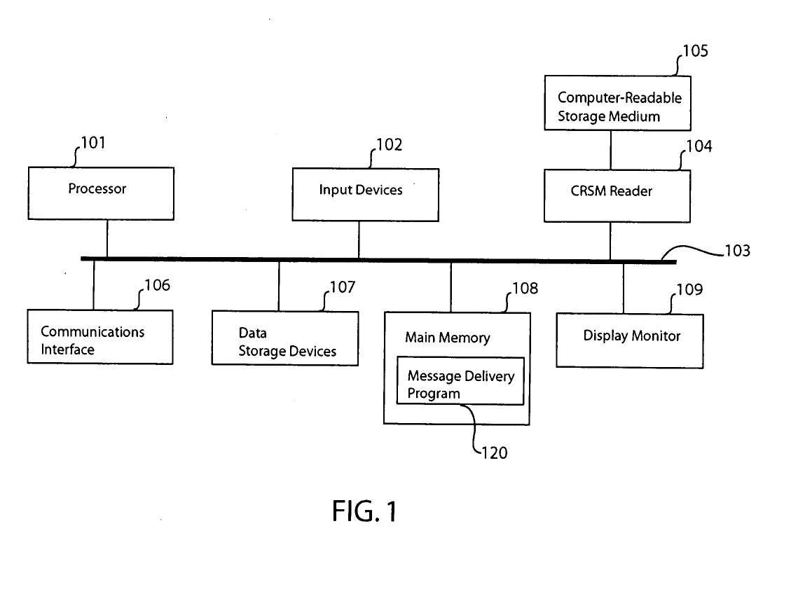

Referring now to FIG. 1, there is shown a schematic diagram of an example computer that may be used in embodiments of the present invention. Depending on its configuration, the computer shown in the example of FIG. 1 may be employed as a client computer, a server computer, or other data processing device. The computer of FIG. 1 may have less or more components to meet the needs of a particular application. As shown in FIG. 1, the computer may include a processor 101, such as those from the Intel Corporation or Advanced Micro Devices, for example. The computer may have one or more buses 103 coupling its various components. The computer may include one ore more input devices 102 (e.g., keyboard, mouse), a computer-readable storage medium (CRSM) 105 (e.g., floppy disk, CD-ROM), a CRSM reader 104 (e.g., floppy drive, CD-ROM drive), a display monitor 109 (e.g., cathode ray tube, flat panel display), a communications interface 106 (e.g., network adapter, modem) for coupling to a network, one or more data storage devices 107 (e.g., hard disk drive, optical drive, FLASH memory), and a main memory 108 (e.g., RAM). Software embodiments may be stored in a computer-readable storage medium 105 for reading into a data storage device 107 or main memory 108. Software embodiments in main memory 108 may be executed by processor 101. In the example of FIG. 1, main memory 108 is shown as having a message delivery program 120, which is further described below. Message delivery program 120 and other programs (not shown) in main memory 108 may be loaded from a computer-readable storage medium 105, a data storage device 107, or over the Internet by way of communications interface 106, for example. Message delivery program 120 and other programs in main memory 108 may be executed by processor 101.

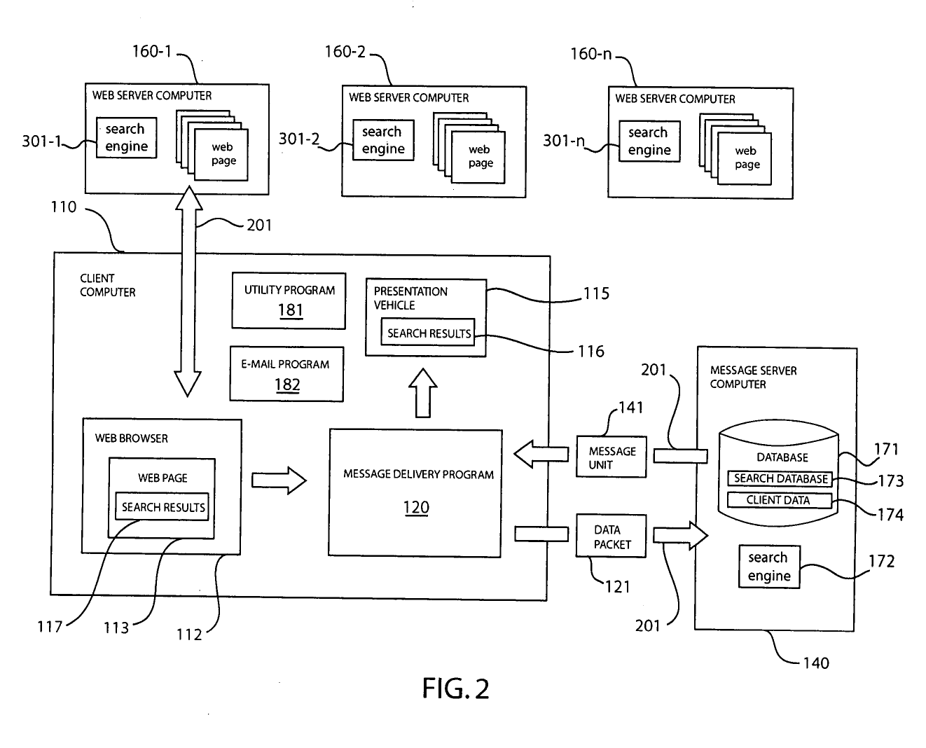

FIG. 2 shows a schematic diagram of a computing environment in accordance with an embodiment of the present invention. In the example of FIG. 2, the computing environment includes one or more web server computers 160 (i.e., 160-1, 160-2, . . . ), one or more client computers 110, one or more message server computers 140, and other computers not specifically shown. In the example of FIG. 2, a client computer 110 communicates with server computers (e.g., a web server computer or a message server computer) over the Internet. As such, arrows 201 denote Internet connections. Intermediate nodes such as gateways, routers, bridges, Internet service provider networks, proxy servers, firewalls, and other network components are not shown for clarity.

A client computer 110 is typically, but not necessarily, a personal computer such as those running the Microsoft Windows™ operating system, for example. An end-user may employ a suitably equipped client computer 110 to get on the Internet and access computers coupled thereto. For example, a client computer 110 may be used to access web pages from a web server computer 160.

A web server computer 160 may be a server computer hosting a website, which comprises web pages designed to attract end-users surfing on the Internet. A web server computer 160 may include advertisements, downloadable computer programs, a search engine, and products available for online purchase. In the example of FIG. 2, web server computers 160 are shown as including search engines 301 (i.e., 301-1, 301-2, . . . ). For purposes of the present disclosure, a web server computer hosting a website or including a search engine is also simply referred to as a “website” or a “search engine,” respectively. As can be appreciated, a website or a search engine may be on one or more server computers.

In the example of FIG. 2, search engines 301 comprise “unrelated search engines” in that they are separately operated by different entities (companies or individuals). That is, web servers 160-1, 160-2, and 160-3, including their search engines, do not interoperate or share information. As an example, the Yahoo! search engine is unrelated to, and in competition with, the Google search engine.

A message server computer 140 may include the functionalities of a web server computer 160. In one embodiment, a message server computer 140 further includes a database 171. Database 171 may be a commercially available database, such as those available from the Oracle Corporation. Database 171, which may comprise one or more databases, may store client data received from message delivery programs 120 running in client computers 110. The client data may be transmitted from a client computer 110 to message server computer 140 in a data packet 121. The client data may include navigation, behavioral, and search data obtained by a message delivery program 120 by monitoring an end-user's online activities. The client data may be stored in a client data database 174 in database 171. As will be explained below, database 171 may also include a search database 173. Search database 173 and client data database 174 may also be stored in separate databases without detracting from the merits of the present invention.

In the example of FIG. 2, message server computer 140 is shown as communicating with one client computer 110 for clarity of illustration. In practice, message server computer 140 receives data packets 121 containing client data from a plurality of client computers 110 that have message delivery programs 120. A message server computer 140 may also include downloadable computer programs and files for supporting, updating, and maintaining software components on a client computer 110.

Message server computer 140 may also include a search engine 172. Search engine 172 is unrelated to any of search engines 301. Search engine 172, in conjunction with a search database 173 in database 171, allows message server computer 140 to perform an Internet search for a keyword using a search algorithm. Search engine 172 and its search engine database 173 may be conventional search engines and databases. Message server computer 140 may also employ the services of external search engines and databases to perform an Internet search. For example, message server computer 140 may pass a keyword to an external search engine to get corresponding search results. Search engines and techniques for performing Internet searches that may also be used in conjunction with the message server computer 140 include those disclosed in commonly-assigned U.S. application Ser. No. 10/289,123, filed Nov. 5, 2002 and U.S. application Ser. No. 10/815,112, filed Mar. 31, 2004, which are both incorporated herein by reference in their entirety.

In one embodiment, message server computer 140 receives search data from message delivery program 120 by way of a data packet 121. The search data may include keywords used by the end-user to perform a search using a search engine 301, the corresponding search results, and the links clicked by the end-user on the search results. In one embodiment, message server computer 140 receives from message delivery program 120 the keyword used by the end-user to perform a search using a search engine 301. Responsive search results 117 from the search engine 301 may be displayed in a web page 113 in a window of web browser 112. Message server computer 140 may use the same keyword to perform another search (e.g. using search engine 172) and provide the corresponding search results to message delivery program 120 by way of message unit 141 for display in a presentation vehicle 115 (e.g. a web browser window). In the example, of FIG. 2, presentation vehicle 115 displays search results 116 which may be from or initiated by message server computer 140. Because search results 117 and 116 are from two different, unrelated search engines, they will have different content and thus advantageously provide the end-user with more information. As will be more apparent below, search results 116 may be formatted and displayed in accordance with an embodiment of the present invention to add features and augment information in a presentation vehicle 115 containing search results 116. For example, presentation vehicle 115 may comprise a web page that has a provision for e-mailing individual search results in search results 116.

Web server computers 160 and message server computers 140 are typically, but not necessarily, server computers such as those available from Sun Microsystems, Hewlett-Packard, or International Business Machines. A client computer 110 may communicate with a web server computer 160 or a message server computer 140 using client-server protocol. It is to be noted that client-server computing is well known in the art and will not be further described here.

As shown in FIG. 2, a client computer 110 may include an e-mail program 182, a web browser 112, and a message delivery program 120. E-mail program 182 may comprise a commercially available e-mail program, such as the Microsoft Outlook™ program. E-mail program 182 allows the end-user to send and receive e-mails over the Internet, for example.

Web browser 112 may be a commercially available web browser or web client. In one embodiment, web browser 112 comprises the Microsoft Internet Explorer™ web browser. A web browser allows an end-user on a client computer to access a web page. In the example of FIG. 2, web browser 112 is depicted as displaying a web page 113 from a web server computer 160. A web page, such as web page 113, has a corresponding address referred to as a “URL” (Uniform Resource Locator). Web browser 112 is pointed to the URL of a web page to receive that web page in client computer 110. Web browser 112 may be pointed to a URL by entering the URL at an address window of web browser 112, or by clicking a link pointed to that URL, for example. A web page may include an area where a keyword may be entered for search purposes. In the example of FIG. 2, web page 113 includes search results 117 from a web server computer 160. Search results 117 may be responsive to a keyword provided by the end-user to a search engine 301. It is to be noted that a keyword may comprise a single word or a phrase.

In one embodiment, message delivery program 120 is downloadable from message server computer 140 or a web server computer 160. Message delivery program 120 may be downloaded to a client computer 110 in conjunction with the downloading of another computer program. For example, message delivery program 120 may be downloaded to client computer 110 along with a utility program 181 that is provided free of charge or at a reduced cost. Utility program 181 may be an e-wallet or calendar program, for example. Utility program 181 may be provided to an end-user in exchange for the right to deliver advertisements to that end-user's client computer 110 via message delivery program 120. In essence, revenue from advertisements delivered to the end-user helps defray the cost of creating and maintaining the utility program. Message delivery program 120 may also be provided to the end-user along with free or reduced cost access to an online service, for example.

Message delivery program 120 is a client program in that it is stored and run in a client computer 110. Message delivery program 120 may comprise computer-readable program code for displaying advertisements in a client computer 110 and for monitoring the online activity of an end-user on the client computer 110. It is to be noted that the mechanics of monitoring an end-user's online activity, such as determining where an end-user is navigating to, the URL and contents (e.g. search results) of web pages received in client computer 110, the domain names of websites visited by the end-user, what the end-user is typing on a web page, what keyword the end-user is providing to a search engine, whether the end-user clicked on a link or an advertisement, when the end-user activates a mouse or keyboard, and the like, is, in general, known in the art and not further described here. For example, message delivery program 120 may learn of end-user online activities by receiving event notifications from web browser 112.

Message delivery program 120 may, with informed consent from the end-user, record the end-user's online activity for reporting to message server computer 140. The recorded end-user online activity is also referred to as “client data,” and provided to message server computer 140 using data packets 121. Preferably, the client data do not contain information that may be used to reveal the identity of the end-user or his personal information. In one embodiment, each end-user is identified by a unique, anonymous user ID to protect end-user privacy.

Message server computer 140 may use the client data to provide targeted advertisements to the end-user. The targeted advertisements may be based on the end-user's online behavior, such as the websites visited by the end-user, the advertisements the end-user clicks on, the amount of time the end-user spends on a website, and so on. Unlike targeted advertisements that rely on end-user provided demographic information, targeted advertisements based on the end-user's online behavior provides a better picture of the end-user's preferences. Message server computer 140 may include the targeted advertisements as suggested search results in a search results web page along with algorithmic search results. Message server computer 140 may also include the targeted advertisement or data for displaying the advertisement in a message unit 141. In the example of FIG. 2, the targeted advertisement is labeled as advertisement 116 and displayed in a presentation vehicle 115. Presentation vehicle 115 may be a pop-under, pop-up, a web browser window, or other means for displaying information on a computer screen. Techniques for delivering advertisements to client computers using a client program are also disclosed in commonly-owned U.S. application Ser. No. 10/152,204, entitled “Method and Apparatus for Displaying Messages in Computer Systems,” filed on May 21, 2002 by Scott G. Eagle, David L. Goulden, Anthony G. Martin, and Eugene A. Veteska, which is incorporated herein by reference in its entirety.

Message server computer 140 may build the search database 173 based on searches performed by end-users on unrelated web sites. In one embodiment, client data provided by a message delivery program 120 to message server computer 140 include the keywords used by end-users to perform a search and the links selected (e.g. by clicking) by end-users from corresponding, responsive search results. As can be appreciated, the links selected by an end-user from search results responsive to the keyword are very relevant to the keyword as they have been essentially “validated” by the end-user. Message server computer 140 may rank these end-user selected links higher than other links for the keyword. Techniques for providing end-user selected/preferred links for providing search results are also disclosed in the above-mentioned U.S. application Ser. No. 10/815,112, filed on Mar. 31, 2004, which is incorporated herein by reference in its entirety.

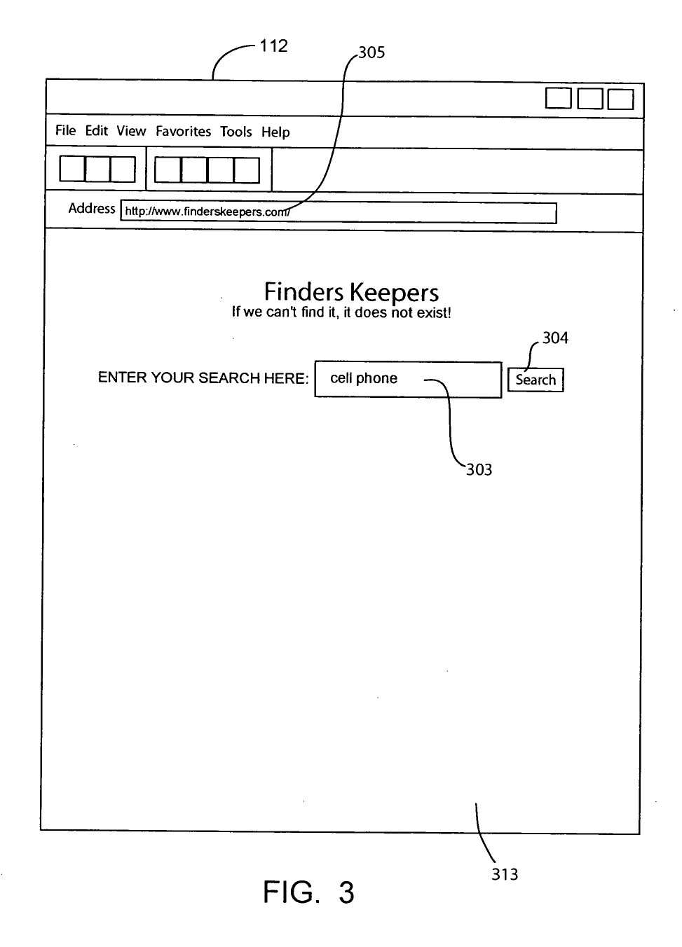

FIG. 3 shows an example web page 313 displayed in a window of web browser 112 in a client computer 110. In the example of FIG. 3, web page 313 is from a search engine 301 of a web server 160. Web page 112 may include an address window 305 indicating the URL of the web page, which is web page 313 in this example, displayed in a window of web browser 112. Web page 313 comprises a search interface of the search engine 301 and accordingly includes a keyword entry field 303 and a search button 304. An end-user may enter one or more keywords in keyword entry field 303 and click on search button 304 to receive a web page containing search results responsive to the keyword. The responsive search results from the search engine 301 may be displayed in a window of web browser 112 in the client computer 110.

In one embodiment, message delivery program 120 provides the keyword entered in a keyword entry field of one search engine, and provides a responsive search results web page from another, unrelated search engine. For example, message delivery program 120 may provide message server computer 140 the keyword entered by the end-user in keyword entry field 303. Message server computer 140 may use the exact same keyword to perform a search using search engine 172 (or an external search engine) to provide the end-user another responsive search results web page. In the example of FIG. 3, the end-user may receive a search results web page responsive to the keyword “cell phone” from the search engine 301 and another search results web page also responsive to “cell phone” from search engine 172. The search results web page from search engine 172 may be displayed under the search results web page from the search engine 301 on the same computer screen at the same time. Using FIG. 2 as an example, the search results web page from the search engine 301 may be displayed as search results 117 in a web page 113, while the search results from the search engine 172 may be displayed as search results 116 in the presentation vehicle 115, which comprises a web page in this particular example.

It is to be noted that a web page may be “displayed” on a computer screen without the web page being visible to the end-user. For example, a first web page may be displayed under a second web page. The end-user can simply select the displayed first web page to bring it into view.

As can be appreciated from the foregoing, the message delivery program 120 facilitates delivery of a search results web page from search engine 172 without the end-user having to manually perform a search on the search engine 172. That is, message delivery program 120 advantageously automatically performs a second search using the same keyword the end-user employed in a manual search, thus allowing the end-user to receive more than one set search results from a single search.

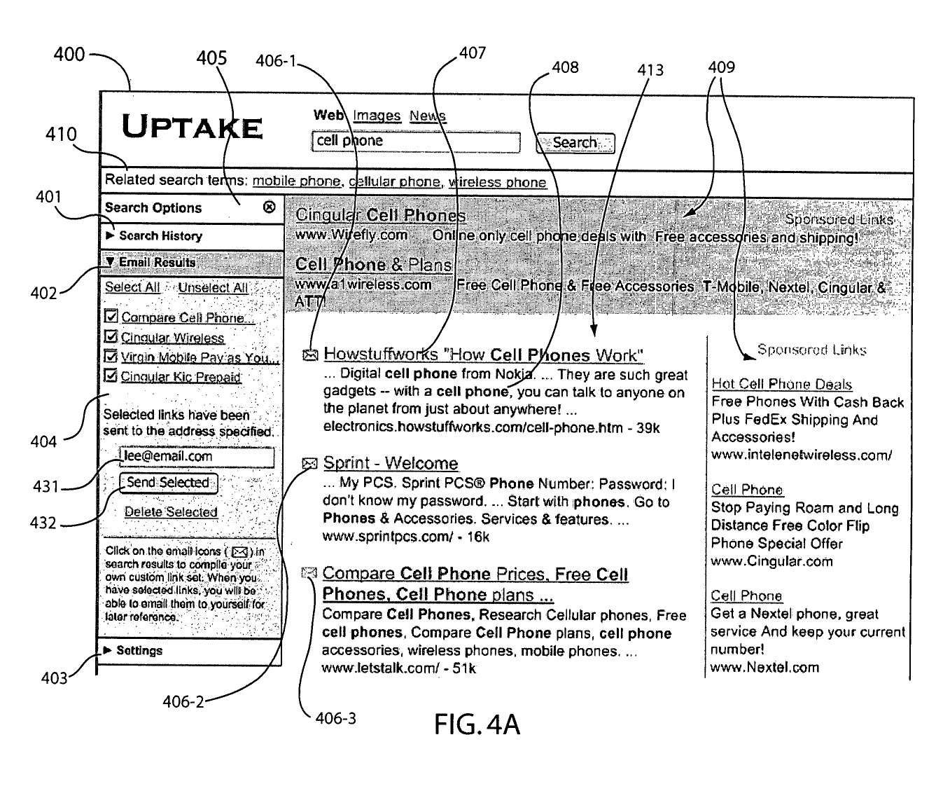

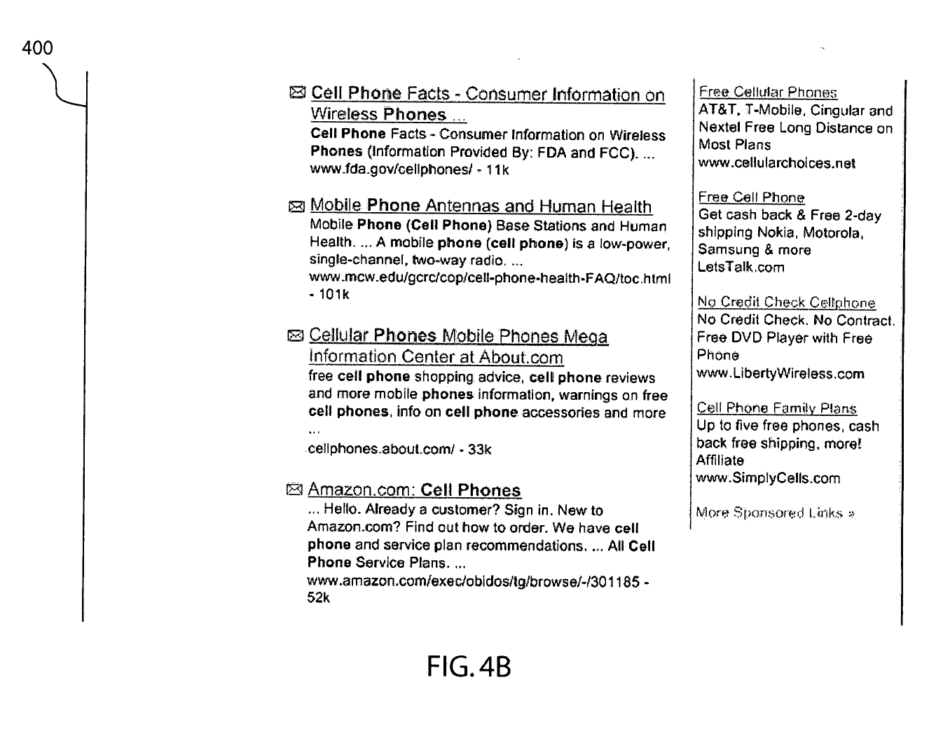

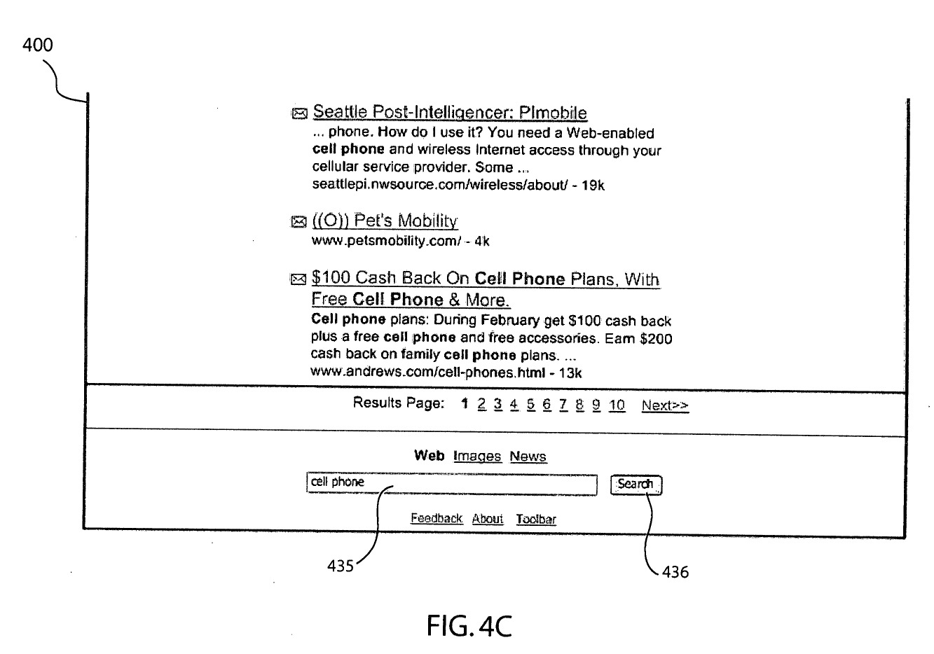

FIG. 4, which consists of FIGS. 4A, 4B, and 4C, shows a search results web page 400 in accordance with embodiment of the present invention. In one embodiment, search results web page 400 comprises search results from search engine 172 of message server computer 140. In the example of FIG. 4, search results web page 400 is responsive to the same keyword (“cell phone” in this example) entered by the end-user in the unrelated search engine 301. Search results web page 400 may comprise algorithmic search results 413 and sponsored search results 409.

In the example of FIG. 4, algorithmic search results 413 comprise links having the headers “Howstuffworks ‘How Cell Phones Work’”, “Sprint—Welcome”, “Compare Cell Phone Prices, Free Cell Phones, Cell Phone plans . . . ” and so on. Algorithmic search results comprise links to web pages that are deemed responsive to the keyword using the search engine's normal search algorithm. As is conventional, algorithmic search results are based primarily on the relevance of the website's web page to the keyword without regard to sponsorship or advertising dollars from the website.

In the example of FIG. 4, sponsored search results 409 comprise links having the headers “Cingular Cell Phones”, “Cell Phone & Plans”, “Hot Cell Phone Deals” and so on. In contrast to algorithmic search results, sponsored search results are essentially advertisements in that they are included in search results in return for advertising fees. A sponsored search result may thus be included in the search results web page whether or not it is relevant to the keyword. A paid inclusion link is a sponsored search result for a particular keyword. The paid inclusion link is included in search results for the keyword whether or not the search engine's search algorithm deems the paid inclusion link particularly relevant.

Referring to FIG. 4A, each search result may include a header 407 and a snippet 408. A header 407 serves as the main text for the search result. A header 407 may be a clickable link that when activated accesses the web page pointed to by the header. A snippet 408 comprises a summary of the web page. Note that a search result may have one or more portions that provide a link to the web page responsive to the keyword.

In one embodiment, search results web page 400 includes a provision for e-mailing individual search results. In the example of FIG. 4A, each algorithmic search result 413 in search results web page 400 includes a clickable e-mail icon 406 (i.e. 406-1, 406-2, . . . ). Activating (e.g. by clicking) an e-mail icon 406 allows the corresponding search result to be e-mailed to one or more recipients. In one embodiment, clicking on an e-mail icon 406 places the corresponding search result in a region 404. That is, the end-user may compile a list of search results to be e-mailed by clicking on the e-mail icon 406 of each search result of interest. For example, clicking e-mail icon 406-3 places the search result having the headers “Compare Cell Phone Prices, Free Cell Phones, Cell Phone plans . . . ” in region 404. Region 404 displays the search results compiled by the end-user by activating individual e-mail icons 406.

In region 404, each search result in the compilation of search results has a corresponding check box that allows the search result to be e-mailed to one or more e-mail addresses listed in e-mail address field 431 by clicking on a send button 432. For example, computer-readable program code of search results web page 400 may provide the selected search results and the e-mail addresses to message server computer 140, which may then e-mail the search results. As another example, message delivery program 120 may invoke e-mail program 182 (see FIG. 2) to create an e-mail having links to the selected search results; the end-user may add a message to the e-mail or e-mail the search results as is. For the convenience of the end-user, all check boxes in region 404 may be selected (e.g. by clicking on “Select All”) or unselected (“e.g. by clicking on “Unselect All”).

The capability to conveniently e-mail individual search results among a plurality of search results advantageously allows an end-user to create a record of a particular search result (by e-mailing himself), which the end-user would not have recorded if the process is relatively complicated. This capability also allows the end-user to readily e-mail individual search results to other people who the end-user believes will be interested in the search result. As can be appreciated, an entire search results may contain too much information to be recorded or e-mailed to other people. Selecting individual search results from a plurality of search results allows the end-user to “filter” the search results, making the compiled search results in region 404 much more useful than the entire search results.

In one embodiment, search results web page 400 also includes related search terms 410. Related search terms 410 comprise one or more keywords related (e.g. a synonym, alternative equivalent term) to the keyword used by the end-user to perform the search. In one embodiment, each related term 410 comprises a clickable text (e.g. “mobile phone”, “cellular phone”, and so on) that when activated performs a search using that related term as the keyword. For example, clicking on “mobile phone” of the related terms 410 tells search engine 172 of the message server computer 140 to perform an Internet search on the keyword “mobile phone” and provide the end-user another search results web page with responsive search results. Related search terms 410 advantageously help end-users pick keywords that may lead to more focused search results.

As shown in FIG. 4A, search results web page 400 may include a Search Options regions 405. Each region of Search Options regions 405 may have a title bar for selecting that region. Accordingly, Search Options regions 405 may include title bars 401, 402, and 403. In one embodiment, a region of Search Options regions 405 vertically expands when its title bar is activated. The tile bar may be activated a second time to unfold the displayed region. In the example of FIG. 4A, title bar 402 was activated to expand region 404. Title bars 401 and 403 are unexpanded in FIG. 4A. As will be more apparent below, Search Options regions 405 may also be implemented as a separate window or another frame of a search results web page.

In one embodiment, clicking on title bar 402, which is labeled “Email Results” in the example of FIG. 4A, expands region 404 for viewing by the end-user. Region 404 has already been discussed above in connection with e-mail icons 406. Title bar 403, which is labeled “Settings” in the example of FIG. 4A, may be clicked to see various user-configurable settings such as font size, number of search results per page, to clear the history, filtering of explicit content, and other options.

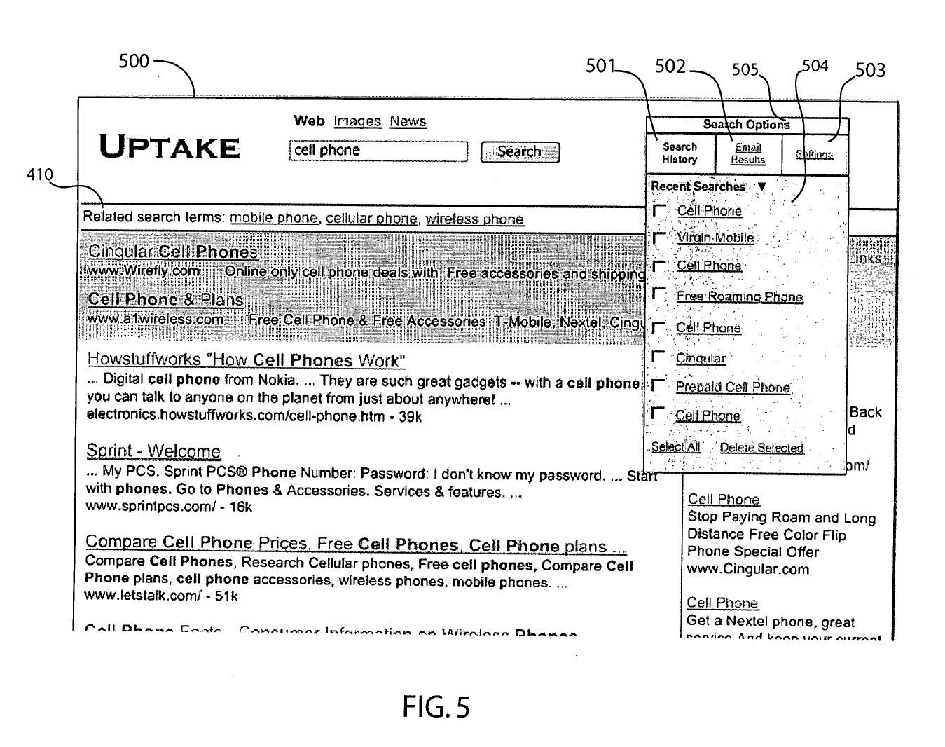

In one embodiment, clicking on title bar 401, which is labeled “Search History” in the example of FIG. 4A, expands a region showing search results clicked by the end-user in previously received search results. Search History regions are further discussed below in connection with title bar 501 of FIG. 5.

FIGS. 4B and 4C show the rest of search results web page 400. FIG. 4B shows the middle portion of search results web page 400, while FIG. 4C shows the bottom portion. Referring to FIG. 4C, search results web page 400 may further include a keyword entry field 435 for entering one or more keywords. Activating search button 436 initiates an Internet search of the entered keywords using search engine 172, for example. As shown in FIG. 4A, a keyword entry field and a send button may also provided on the top portion of search results web page 400.

FIG. 5 shows a search results web page 500 in accordance with an embodiment of the present invention. In the example of FIG. 5, Search Options regions 505 are implemented as a separate window. Search Options regions 505 may also be implemented as a separate frame of search results web page 500, for example. Search options regions 505 include title bars 501, 502, and 503, which provide the same functionality as title bars 401, 402, and 403, respectively, of Search Options regions 405.

Still referring to FIG. 5, there is shown a region 504 containing search results (“Cell Phone”, “Virgin Mobile”, and so on) that were previously clicked by the end-user to access the web page pointed by the search result. In the example of FIG. 5, activating title bar 501 opens region 504. The search results in region 504 may be from currently or previously received search results. The search results in region 504 are automatically compiled as the end-user clicks on web page links in a search results web page. Region 504 (and 404) advantageously allows the end-user to go back to previously clicked search results. In region 504, individual search results may be selected or deselected by checking or un-checking a corresponding check box. All search results in region 504 may be selected by activating the clickable text “Select All”. Selected search results may be deleted from region 504 by activating the clickable text “Delete Selected”. Each search result in region 504 may be activated to receive the web page pointed by the search result.

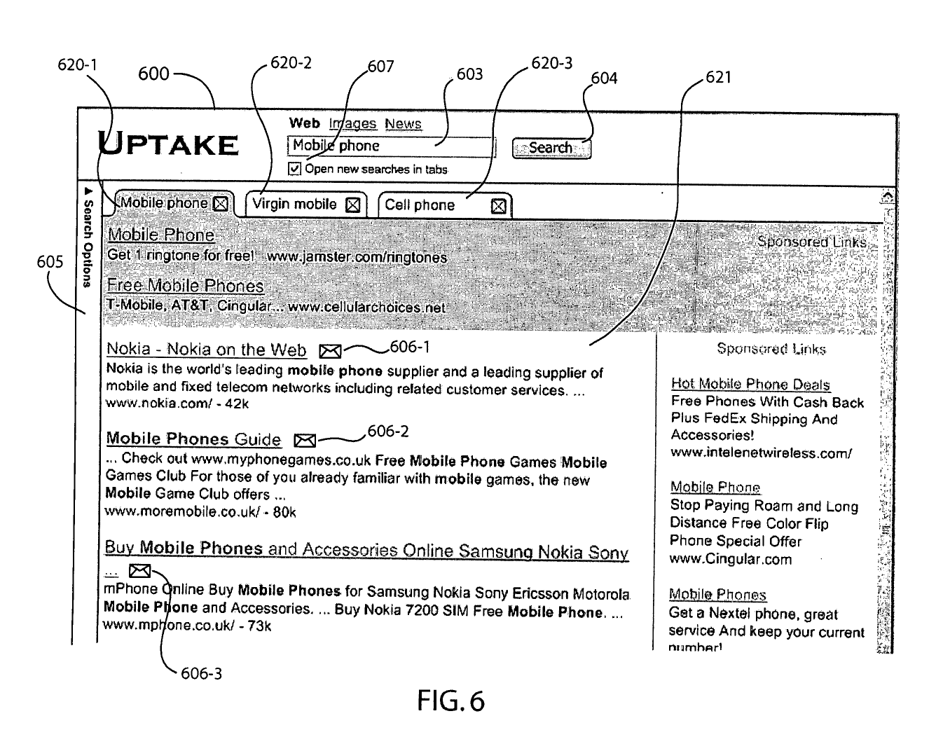

Referring now to FIG. 6, there is shown a search results web page 600 in accordance with an embodiment of the present invention. Search results web page 600 may have the same features as search results web pages 400 and 500. For example, search results web page 600 may include Search Options regions 605, keyword entry field 603, and send button 604 similar to those in search results web pages 400 and 500. In one embodiment, search results web page 600 further includes an option for displaying different search results in different display regions 621, which may be selectable by tabs. In the example of FIG. 6, checking check box 607 displays in a separate tabbed display region 621 the search results for the keyword entered in entry field 603 and sent to the search engine by activating send button 604. FIG. 6 shows an example where tab 620-1 is selected to display the search results for the keywords “Mobile phone.” When selected, tabs 620-2 and 620-3 display search results for the keywords “Virgin mobile” and “Cell phone”, respectively.

Displaying different search results on the same search results web page provides several advantages. Displaying different search results in selectable tabbed display regions minimizes desktop clutter and allows the end-user to readily access search results. As another advantage, Search Options 605 may be implemented such that it is common to all of the search results. This allows the end-user to select individual search results from different search results to be e-mailed to one or more recipients. For example, the end-user may select individual search results from tab 620-1 by clicking on the corresponding e-mail icon 606 (i.e. 606-1, 606-2, . . . ). The end-user may do the same for search results in tabs 620-2 and 620-3. The selected search results may be compiled in an Email Results region (similar to region 404 shown in FIG. 4A) of Search Options regions 605. When done selecting individual search results from different search results, the end-user may enter one or more e-mail addresses in an e-mail address field and activate a send button in the Email Results region to forward the compiled search results to the indicated addresses. As can be appreciated, the capability to e-mail selected search results from different search results advantageously makes the task of forwarding search results much easier and convenient, thereby encouraging end-users to forward search results.

Improved search results web pages have been disclosed. While specific embodiments of the present invention have been provided, it is to be understood that these embodiments are for illustration purposes and not limiting. Many additional embodiments will be apparent to persons of ordinary skill in the art reading this disclosure.

1. A search results web page comprising:
a first set of search results for a first Internet search, each search result in the first set of search results including an icon for including the search result in a compilation of search results;
a first region displaying the compilation of search results, the first region including a provision for e-mailing selected search results in the compilation of search results; and
a second region displaying links to web pages previously activated by an end-user from a second set of search results for a second Internet search.

2. The web page of claim 1 wherein the search results web page is displayed along with another search results web page on the same computer screen, the search results web page and the other search results web page containing search results that are responsive to the same keyword.

3. The web page of claim 1 wherein the provision for e-mailing the selected search results in the compilation of search results comprises:
an e-mail address entry field for entering one or more e-mail addresses; and
a send button for e-mailing the selected search results in the compilation of search results to e-mail addresses entered in the e-mail address entry field.

4. (canceled)

5. The web page of claim 1 further comprising:
a third set of search results for a third Internet search included in the search results web page along with the first set of search results, each search result in the third set of search results including an icon for including the search result in the compilation of search results;
wherein the first set of search results and the third set of search results are responsive to different keywords.

6. (canceled)

7. The web page of claim 1 wherein the search results web page includes clickable texts of terms related to a keyword employed by an end-user to obtain the first set of search results, wherein clicking on a term initiates an Internet search using the term as a keyword.

8. A method of providing search results to an end-user, the method comprising:
detecting a search request from a client computer to a first search engine;
delivering to the client computer a second search results web page from a second search engine, the second search results web page being displayed on the same computer screen as a first search results web page from the first search engine, the first and second search engines being unrelated search engines, the first search results web page displaying a first set of search results and the second search results web page displaying a second set of search results, the first and second sets of search results being responsive to a same first keyword, the second search results web page being automatically delivered to the client computer without an end-user of the client computer performing a search on the second search engine; and
e-mailing search results selected by the end-user from the second search results web page.

9. The method of claim 8 further comprising:
delivering to the client computer a third set of set search results responsive to a second keyword that is different from the first keyword, the third set of search results being displayed in the second search results web page; and
e-mailing search results selected by the end-user from the second and third search results web pages.

10. (canceled)

11. The method of claim 8 further comprising:
displaying in the second search results web page search results that were previously selected by the end-user from other previously received search results.

12. A search results web page comprising:
a first set of set results in a first search results web page, the first set of search results being displayed at the same time on the same computer screen as a second set of search results in a second search results web page, the first and second sets of search results being from two different unrelated search engines and responsive to a same first keyword;
a provision for e-mailing individual search results from the second set of search results.

13. The web page of claim 12 wherein the second search results web page is displayed under the first search results web page.

14. The web page of claim 12 wherein the provision for e-mailing individual search results from the second set of search results comprises:
an icon for each search result in the second set of search results, the icon being configured to allow an end-user to select a search result in the second set of search results to be included in a compilation of search results;
an e-mail address entry field configured to receive an e-mail address; and
a send button configured to initiate e-mailing of selected search results in the compilation of search results to the e-mail address.

15. The web page of claim 12 further comprising:
a third set of search results included in the second search results web page along with the second set of search results, the third set of search results being responsive to a second keyword that is different from the first keyword; wherein the provision allows for e-mailing individual search results from the second set of search results and the third set of search results.

16. (canceled)

17. The web page of claim 12 further comprising:
an icon for each search result in the second set of search results, the icon being configured to allow an end-user to select a search result in the second set of search results to be included in a compilation of search results; and
a first region displaying the compilation of search results.

18. The web page of claim 17 further comprising:
a second region displaying links to web pages previously activated by the end-user from previously received search results.

19. The web page of claim 12 further comprising:
a plurality of related search terms that are related to the first keyword, wherein each related search term is presented as clickable text that when activated performs a search using the related search term as a keyword.

20. The web page of claim 12 further comprising:
a keyword entry field and a search button for allowing an end-user to perform a search using the second search results web page.
